(19) United States
(12) Patent Application Publication
(10) Pub. No.: US 2012/0079011 A1
(43) Pub. Date: Mar. 29, 2012

(54) OPERATION SUPPORT SYSTEM

(75) Inventor: Hiromitsu Takayama, Tokyo (JP)

(73) Assignee: Hiromitsu Takayama, Tokyo (JP)

(21) Appl. No.: 13/240,280

(22) Filed: Sep. 22, 2011

(30) Foreign Application Priority Data
Sep. 28, 2010 (JP) 2010-216681

(51) Int. Cl. G06F 15/16

(52) U.S. Cl. 709/203

(57) ABSTRACT

Pinup board information is stored in a storage part of an operation support server 20. This pinup board information holds, for each user of a client terminal device 10ⱼₖ, correspondence between display positions and identifiers upon pinup board screens of anchor icons each of which corresponds to a destination for access by the user, and access destination specifications corresponding to those anchor icons. Editing of the pinup board information is performed by employing the client terminal device 10ⱼₖ. When a command is inputted to select a single anchor icon that is included upon a pinup board screen being displayed upon the display part of the client terminal device 10ⱼₖ, the client terminal device 10ⱼₖ accesses the access destination that corresponds to the selected anchor icon. As a result, convenience and efficiency are improved for the user when performing operation to access content of various types.

### RELATED APPLICATION

This application is based on and claims the priority of Japanese patent application No. 2010-216681 filed on Sep. 28, 2010, the content of which is hereby incorporated herein by reference.

### BACKGROUND OF THE INVENTION

The present invention generally relates to an operation support system that supports input operations by users on one or more client terminal device.

### BACKGROUND ART

In the past, it has been widely practiced to peruse content on a server device from a client terminal device via a network (such as, the internet). However, during such perusal, it is necessary to input the URL (Uniform Resource Locator) of a content site; and many techniques are employed for registering in advance as a bookmark the URL of a content site that can then be visited as many times as desired.

It is generally practiced for the user himself to input such a bookmark registration and to register it within the client terminal device that he himself is employing. However, with this, the types of bookmarks that can be used are limited.

Because of this, a technique has been proposed (refer to Japanese Laid Open Patent Publication 2008-171295, which subsequently will be termed the “prior art example”) with which the convenience to the user is enhanced by making it possible for him to input a bookmark that is registered on some other client terminal device of another person, rather than on his own client terminal device. With the technique of this prior art example, a bookmark supplying user terminal transmits a bookmark that it is storing internally to a bookmark management server, and registers it in the bookmark management server. The bookmark management server in which the bookmark has thus been registered in this manner then publishes its registered bookmarks on a website to each of the users whom it supplies; and when an acquisition request arrives from a terminal designating a user who is to be supplied with a bookmark that he wishes to acquire, it extracts the corresponding bookmark and transmits it to the bookmark acquisition terminal.

### SUMMARY OF THE INVENTION

The above described technique of the prior art example is a technique, which in terms of supplying a working environment, is convenient when a user employs some specific client terminal device and performs perusal of various websites. However, for a client terminal device other than that specific client terminal device, it is normal for the same level of labor to be required as upon the specific client terminal device for upkeep of the same operating environment as that of the specific client terminal device.

Accordingly, if the user possesses a plurality of client terminal devices (for example, a client terminal device that he uses at home and a client terminal device that he uses on business trips), then it has been difficult for him to be able, in an extremely simple manner, to perform upkeep, on the client terminal device that is for use on business trips, of a similar operating environment to the operating environment that he keeps up on the client terminal device that he employs at home. Thus, it often happens that it is not possible for the user to go off on a sudden business trip without abandoning upkeep of the familiar operating environment to which he is accustomed.

Furthermore with the prior art technique, while it is possible to form bookmarks, which are one type of anchor corresponding to URLs, into a tree structure, the way in which bookmarks are displayed is a display mode that assumes that the user is a typical one. However, in actuality, each user wishes to display anchors in a display mode for which the convenience of use is high from his own point of view.

The present invention has been conceived in consideration of the circumstances described above, and takes as its objective to supply an operation support system that can enhance the convenience for the user when performing operation to access content of various types.

The operation support system of the present invention comprises a client terminal device that comprises a display part and an operation input part and that is endowed with a browsing function, and an operation support server that is connected to said client terminal device via the internet and that, during browsing operation by said client terminal device, supports input operation by the user of said client terminal device, and is wherein: said operation support server comprises: a storage part in which is stored pinup board information, for each user of said client terminal device, in which correspondence is maintained between display positions upon a pinup board screen of anchor icons each of which is an anchor symbol corresponding to a destination for access by said user, identifiers of said anchor icons, and access destination specifications corresponding to said anchor icons; an updating part that, when a result of editing said pinup board information is received from said client terminal device, updates said pinup board information on the basis of said result of editing; and a pinup board screen information return part that, when a request for information for display of said pinup board screen has been received from said client terminal device, generates a display information of said pinup board screen on the basis of said pinup board information, and returns said display information that has been generated to said client terminal device; and said client terminal device comprises: an editing part that performs editing according to an editing command for said pinup board information inputted to said operation input part, and that sends said result of editing to said operation support server; a pinup board request part that, when a command for display of said pinup board screen has been inputted to said operation input part, sends a request for information for display of said pinup board screen to said operation support server; and a web access part that when, in response to the request for information for display of said pinup board screen, a selection has been inputted to said operation input part of a single anchor icon on a pinup board screen that has been displayed on the basis of the display information of said pinup board screen returned from said operation support server, accesses the access destination that corresponds to said selected anchor icon.

With this operation support system, the pinup board information is stored in the storage part of the operation support server. In this pinup board information, for each user of the client terminal device, the display positions upon pinup board screens of anchor icons, which are anchor symbols each of which corresponds to a destination for access by the user, the identifiers of these anchor icons, and the access destination specifications corresponding to these anchor icons are kept in mutual correspondence.

Editing of this type of pinup board information is performed by the client terminal device. During editing of this pinup board information, first, an editing screen that reflects the pinup board screen based upon the pinup board information within the storage part of the operation support server is displayed as an initial screen. And, according to editing commands that are inputted to the operation input part by the user who issues them while referring to the display upon the display part, the editing part performs editing while changing the display contents of the editing screen. When this editing is completed, the editing part sends the result of editing to the operation support server.

In the operation support server, the updating part receives the result of editing of the pinup board information sent from the client terminal device. And the updating part updates the contents of the pinup board information within the storage part to contents that correspond to this result of editing.

Furthermore, when a command for display of a pinup board screen is inputted to the operation input part of the client terminal device, the pinup board request part sends a request to the operation support server for pinup board screen display information. In the operation support server, the pinup board screen information return part receives this request for pinup board screen display information. The pinup board screen information return part creates the display information of the pinup board screen that has been requested by referring to the pinup board information that corresponds to the pinup board screen, and returns this display information of the pinup board screen that it has created to the client terminal device.

In the client terminal device, the web access part receives the display information of the pinup board screen. Next, the web access part displays the pinup board screen upon the display part on the basis of the display information of the pinup board screen. Subsequently, when a selection for a single anchor icon upon the pinup board screen that has been displayed is inputted to the operation input part, the web access part accesses the access destination that corresponds to this selected anchor icon. As a result, the content of the access destination corresponding to the selected anchor icon is presented by the client terminal device to the user for perusal.

Thus, according to the operation support system of the present invention, even if the user possesses a plurality of client terminal devices, it is possible, by employing pinup board information that is stored in the storage part of the operation support server, for him to dispense with the task of maintaining an operating environment on each of these terminal devices for accessing content. Moreover, since the user is able to edit the pinup board information to the details that he desires, it is consequently possible for him to customize the pinup board screens to a style for which the convenience of use from his point of view is good. Thus, it is possible to enhance the convenience for the user when he performs operation to access content of various types.

With the operation support system of the present invention, it may also be arranged for editing for addition of a new anchor icon, editing for changing of the display position of at least a single already existing anchor icon, and editing for deletion of at least a single already existing anchor icon to be included in the editing of said pinup board information. In this case, it is possible to arrange the anchor icons that have been selected by the decision of the user at display positions that are more freely set by the user, so that they are grouped into sets that follow the way of thinking or the conceptualization of the user.

Furthermore, with the operation support system of the present invention, it may also be arranged for the editing part to perform editing for the creation of a new pinup board. When creating a new pinup board in this manner, it is possible to arrange for the creation of this new pinup board at a lower level than the pinup board that corresponds to the pinup board screen; alternatively, it is also possible to create it in a manner that is not related to the pinup board that corresponds to the pinup board screen.

Here, it may also be arranged for the new pinup board to include at least a single anchor icon displayed upon the pinup board screen. In this case, if for example the number of anchor icons upon a single pinup board screen increases so as to become too great, then it is possible to separate these anchor icons upon this single pinup board screen into two groups while emphasizing the degree of organic correlation between these anchor icons from the point of view of the user.

As described above, if the new pinup board includes at least a single anchor icon that is being displayed upon the pinup board screen, then it may be arranged for the editing part to send to the operation support server, as the result of editing, information for creating a new pinup board including an anchor icon that has been shifted to a predetermined region upon the editing screen of the pinup board that corresponds to said pinup board screen. In this case, it is possible to separate the anchor icons upon a single pinup board screen between two pinup board screens by an operation that is extremely simple from the point of view of the user.

Here, it may be arranged for the new pinup board to be created at a lower level than the pinup board that corresponds to the pinup board screen, and for an icon for the new pinup board to be displayed upon the pinup board screen. In this case, when a new pinup board has been created at a lower level than the pinup board that corresponds to a pinup board screen, by arranging to display an icon for the new pinup board within the pinup board screen, it becomes possible to display a pinup board screen that corresponds to the new pinup board by selecting this icon for the new pinup board that is being displayed upon the pinup board screen.

It should be understood that, with the operation support system of the present invention, it may be arranged for either an access destination within the operation support server, or an access destination within a server other than the operation support server and that is connected thereto by the internet, to be selected for the access destination that corresponds to each of the anchor icons.

As has been explained above, according to the operation support system of the present invention, the advantageous effect is obtained whereby it is possible to enhance the convenience to the user when he performs operation in order to access content of various types.

### BRIEF DESCRIPTION OF THE DRAWINGS

FIG. 1 is a block diagram schematically showing the structure of an operation support system according to an embodiment of the present invention;

FIG. 2 is a block diagram showing the structure of a client terminal device of FIG. 1;

FIG. 3 is a block diagram showing the structure of an operation support server of FIG. 1;

FIG. 4 is a figure for an explanation of the contents of pinup board summary information (PSI) of FIG. 3;

FIG. 5 is a figure for an explanation of the contents of anchor icon information (AII) of FIG. 3;

FIG. 6 is a figure showing an example of a home screen directly after log-in;

FIG. 7 is a sequence figure for an explanation of processing for editing of pinup board information;

FIG. 8 is a figure for an explanation of an example of a pinup board screen before editing;

FIG. 9 is a figure showing an example of an initial editing screen (the first part thereof);

FIG. 10 is a figure for an explanation of an editing screen after shifting of the display positions of anchor icons upon the screen of FIG. 9;

FIG. 11 is a figure for an explanation of the contents of pinup board summary information (PSI) that has been updated after editing to shift the display positions of anchor icons;

FIG. 12 is a figure for an explanation of the contents of anchor icon information (AII) that has been updated after editing to shift the display positions of anchor icons;

FIG. 13 is a figure for an explanation of a new pinup board screen after editing;

FIG. 14 is a figure showing an editing screen during selection of anchor icon addition;

FIG. 15 is a figure showing an example of a screen for designation of the title and the type of a new anchor icon;

FIG. 16 is a figure showing an example of a screen for designation of an access designation corresponding to a new anchor icon;

FIG. 17 is a figure for an explanation of an editing screen to which a new anchor icon has been added;

FIG. 18 is a figure showing an editing screen during selection of anchor icon deletion;

FIG. 19 is a figure showing an example of a screen for selection of an anchor icon to be deleted;

FIG. 20 is a figure for an explanation of an editing screen after deletion of an anchor icon;

FIG. 21 is a figure for an explanation of the contents of pinup board summary information (PSI) that has been updated after editing for anchor icon addition and deletion as shown in FIGS. 14 through 20;

FIG. 22 is a figure for an explanation of the contents of anchor icon information (AII) that has been updated after editing for anchor icon addition and deletion as shown in FIGS. 14 through 20;

FIG. 23 is a figure showing an example of an initial editing screen (the second part thereof);

FIG. 24 is a figure showing an editing screen during selection for creation of a new pinup board on a lower level;

FIG. 25 is a figure showing an example of a screen for specification of the title of this new pinup board on a lower level;

FIG. 26 is a figure for an explanation of an editing screen for the higher level pinup board on which an icon for the new pinup board on a lower level is displayed;

FIG. 27 is a figure showing an example of an editing screen for the new pinup board on a lower level;

FIG. 28 is a figure for an explanation of the contents of pinup board summary information (PSI) that has been updated after editing to add a new pinup board on a lower level as shown in FIGS. 23 through 27;

FIG. 29 is a figure for an explanation of the contents of anchor icon information (AII) that has been updated after editing to add a new pinup board on a lower level as shown in FIGS. 23 through 27;

FIG. 30 is a drawing that repeats FIG. 6;

FIG. 31 is a sequence figure for an explanation for a process in adding a new pinup board in the display state shown in FIG. 30;

FIG. 32 is a figure showing an example of a screen for specification of the title of a new pinup board;

FIG. 33 is a figure for an explanation of a home screen to which this new pinup board has been added;

FIG. 34 is a figure for an explanation of the contents of pinup board summary information (PSI) that has been updated after editing to add a new pinup board as shown in FIGS. 30 through 33; and

FIG. 35 is a sequence figure for an explanation of content access processing.

### DETAILED DESCRIPTION

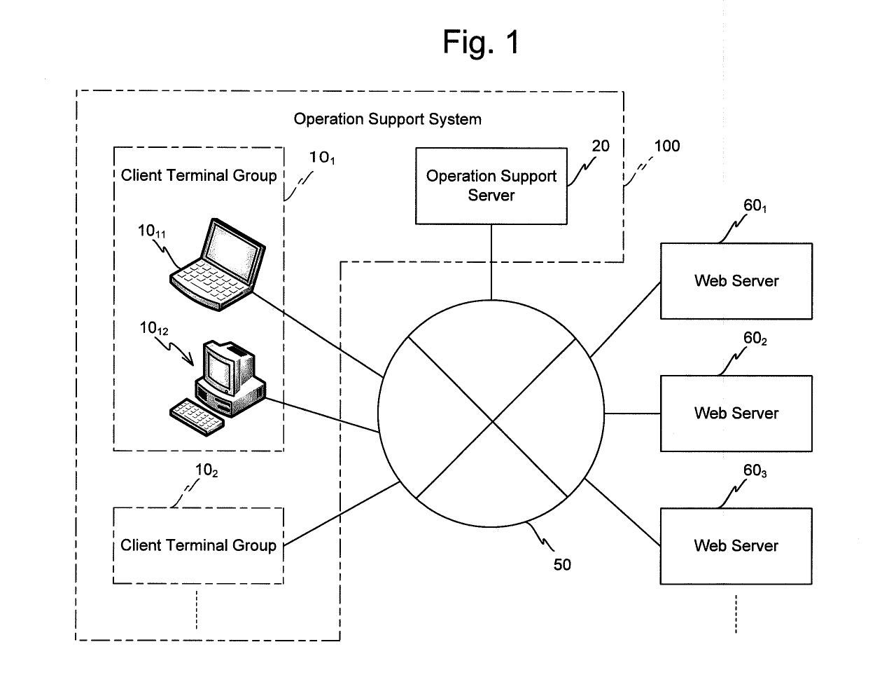

In the following description, an embodiment of the present invention will be explained with reference to FIGS. 1 through 35. It should be understood that, in the drawings and in the following explanation, the same reference symbols will be appended to elements that are the same or equivalent, and duplicated explanation will be omitted.

### [Structure]

The schematic structure of an operation support system 100 according to an embodiment is shown in FIG. 1. As shown in this figure, this operation support system 100 comprises client terminal groups 10₁, 10₂, . . . and an operation support server 20. Each of the client terminal groups 10ⱼ (where j=1, 2, . . . ) comprises one or more client terminal devices 10ⱼₖ (where k=1, 2, . . . ) that are possessed by the same user.

It should be understood that, in FIG. 1, a representative example is shown in which the client terminal group 10₁ includes two client terminal devices 10₁₁ and 10₁₂. Here, the client terminal device 10₁₁ is a notebook type personal computer, and is a portable terminal device that the user (USER₁) takes along with him when going out, for example, on a business trip or the like. The client terminal device 10₁₂ is a desktop type personal computer that is used by the user (USER₁) at his home location, such as in his house.

Each of the client terminal devices 10ⱼₖ is connected to the internet 50. Moreover, the operation support server 20 is also connected to the internet 50. Consequently, each of the client terminal devices 10ⱼₖ is capable of interchanging information and data with the operation support server 20. Furthermore, each of the client terminal devices 10ⱼₖ is also capable of interchanging information and data with web servers 60₁, 60₂, . . . that are connected to the internet 50.

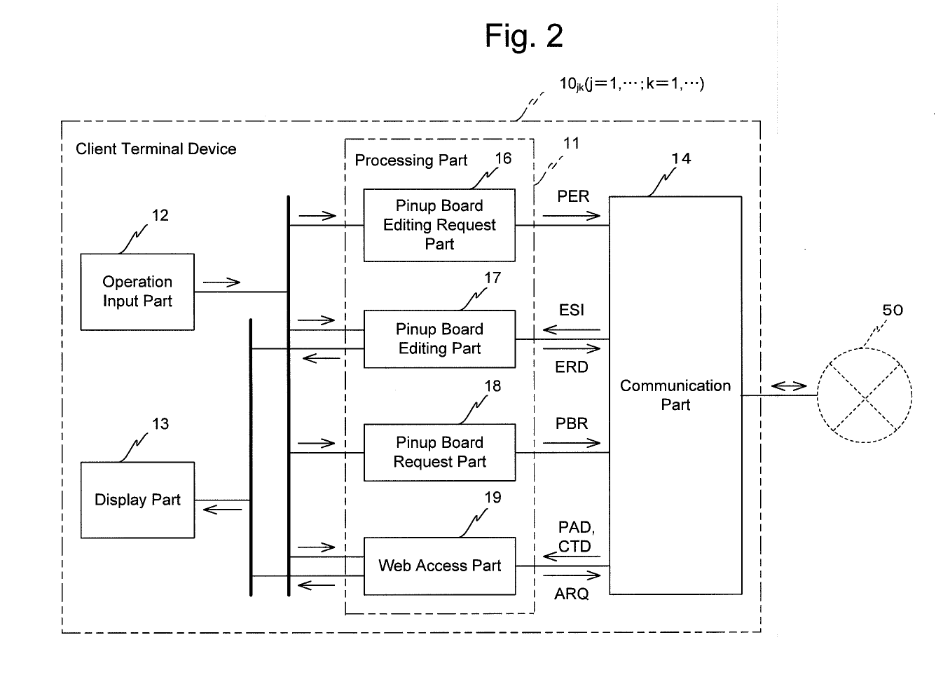

As shown in FIG. 2, each of the client terminal devices 10ⱼₖ described above comprises a processing part 11, an operation input part 12, and a display part 13. Moreover, each of the client terminal devices 10ⱼₖ also comprises a communication part 14.

The processing part 11 discussed above includes a central processing device, and, by executing programs of various kinds, performs processing of various types in order to implement the functions of its client terminal device. The structure of these processing parts 11 will be described hereinafter.

The operation input part 12 discussed above includes a stroke device such as a keyboard or the like and a pointing device such as a mouse or the like. The results of employment by the user of the operation input part 12 are sent to the processing part 11.

The display part 13 described above includes a display device such as a liquid crystal display device or the like. This display part 13 provides a screen display according to display data sent from the processing part 11.

During communication of information by the processing part 11 via the internet 50, the communication part 14 discussed above functions as an interface between the processing part 11 and the internet 50. This communication part 14 receives data for transmission from the processing part 11 and sends this data for transmission out to the internet 50. Moreover, the communication part 14 also receives data from the internet 50, and sends this received data to the processing part 11.

Next, the structure of the processing part 11 described above will be explained. This processing part 11 comprises a pinup board editing request part 16 and a pinup board editing part 17 that serves as an editing part. Moreover, the processing part 11 also comprises a pinup board request part 18 and a web access part 19.

The pinup board editing request part 16 discussed above receives a command that is inputted to the operation input part 12 for starting the editing of pinup board information. Upon receipt of this editing start command, the pinup board editing request part 16 sends an edit request PER for pinup board information to the operation support server 20 via the communication part 14 and the internet 50.

As a response to this editing request PER, the pinup board editing part 17 discussed above receives edit information ESI that has arrived from the operation support server 20 via the internet 50 and the communication part 14. And the pinup board editing part 17 creates initial editing screen data on the basis of this edit information ESI, and sends this data to the display part 13. As a result, an initial editing screen is displayed upon the display part 13.

Subsequently, upon receipt of editing commands inputted to the operation input part 12, while referring to the display upon the display part 13, the pinup board editing part 17 performs pinup board information editing tasks according to those editing commands. When an editing end command has been inputted by the user is notified from the operation input part 12, the pinup board editing part 17 sends the result of editing ERD to the operation support server 20 via the communication part 14 and the internet 50.

It should be understood that the details of the editing processing by the pinup board editing part 17 will be described hereinafter.

The pinup board request part 18 discussed above receives a pinup board screen display command inputted to the operation input part 12. Upon receipt of this display command, the pinup board request part 18 sends a pinup board screen display information request PBR to the operation support server 20 via the communication part 14 and the internet 50.

As a response to this display information request PBR, the web access part 19 discussed above receives pinup board screen display information PAD that has arrived from the operation support server 20 via the internet 50 and the communication part 14. The web access part 19 creates pinup board screen data on the basis of this display information PAD, and sends this data to the display part 13. As a result, the pinup board screen is displayed upon the display part 13.

Upon notification of the fact that selection designation input has been performed by the user upon the operation input part 12 for a single one of the anchor icons that are being displayed within the pinup board screen that has been displayed in this manner, the web access part 19 sends an access request ARQ to the access destination corresponding to the selected anchor icon via the communication part 14 and the internet 50, to that access destination. Upon receipt of content data CTD transmitted from that access destination via the internet 50 and the communication part 14 in response to this access request ARQ, the web access part 19 creates content data for screen display on the basis of this content data CTD, and sends it to the display part 13. As a result, the content that has been accessed is displayed upon the display part 13, and is presented to the user for perusal.

Note that the access destinations of the web access part 19 include both of the web servers 60ₚ (where p=1, 2, . . . ) and the operation support server 20. In the following description, along with the use of the term “access request ARQ₁” for an access request when the access destination is any one of the web servers 60ₚ (where p=1, 2, . . . ), the term “access request ARQ₀” will be used for an access request when the access destination is the operation support server 20, and the term “access request ARQ” will be employed when they are both being referred to generically.

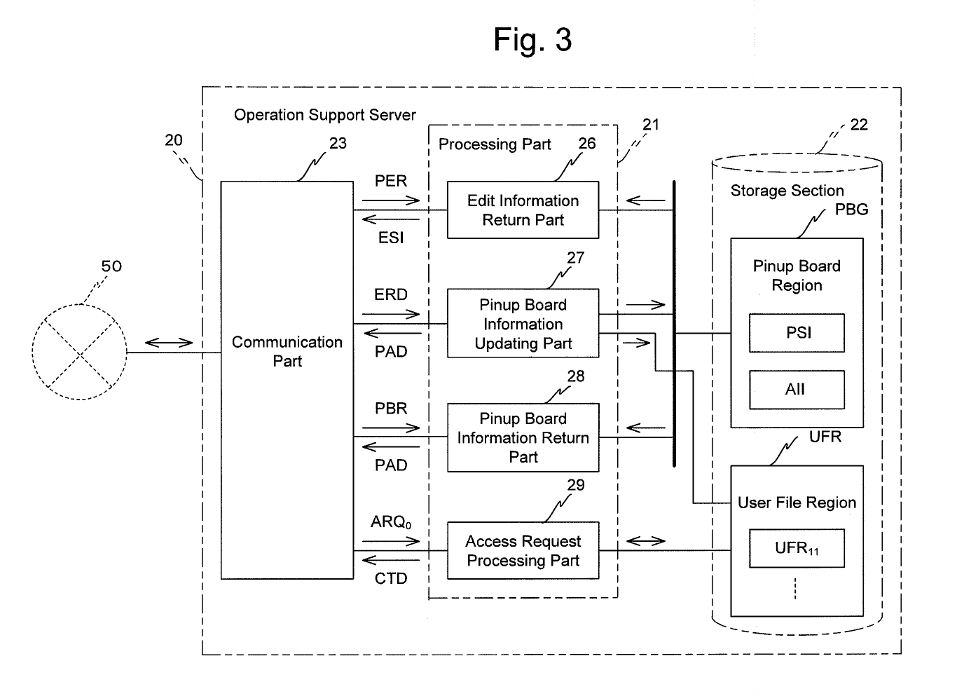

Returning to FIG. 1, the operation support server 20 described above performs support for upkeep of a web access operating environment on each of the client terminal devices 10ⱼₖ. As shown in FIG. 3, this operation support server 20 comprises a processing part 21, a storage part 22, and a communication part 23.

The processing part 21 discussed above includes a central processing device, and, by executing programs of various kinds, performs the processing of various types in order to implement the functions of the operation support server 20. The structure of this processing part 21 will be described hereinafter.

The storage part 22 discussed above includes a high capacity storage device (such as, a hard disk device or the like), and stores information and data of various kinds. The processing part 21 is able to access this storage part 22.

A pinup board region PBG and a user file region UFR are set up in the storage part 22. Pinup board summary information PSI and anchor icon information AII are stored in the pinup board region PBG, while user files UFRⱼₜ (where t=1, . . . ) that have been created by users (USER, where j=1, . . . ) are stored in the user file region UFR.

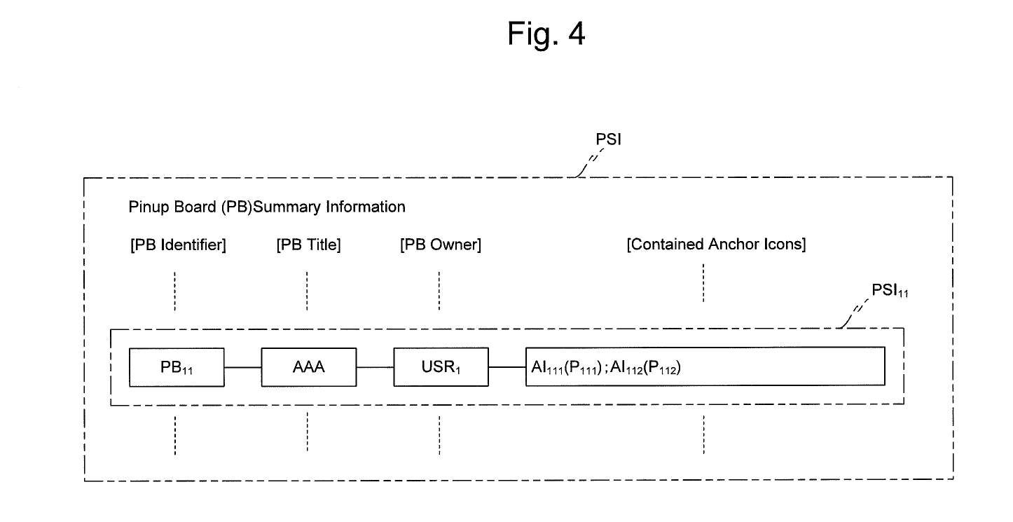

As shown in FIG. 4, individual items of pinup board information PSI_{jq} (where j=1, . . . and q=1, . . . ) are included in the pinup board summary information PSI discussed above. Here, the value of the suffix j corresponds to the user in question.

In each of the individual items of pinup board information PSI_{jq}, a pinup board (hereinafter abbreviated as “PB” when appropriate) identifier that serves as a key, the PB title, the PB owner (i.e. its user), and anchor icons that it contains are held in mutual correspondence. Here, it is arranged for each of these contained anchor icons to include an anchor icon identifier AI_{jqr} (where r=1, . . . ) and its position P_{jqr} for display on the pinup board screen.

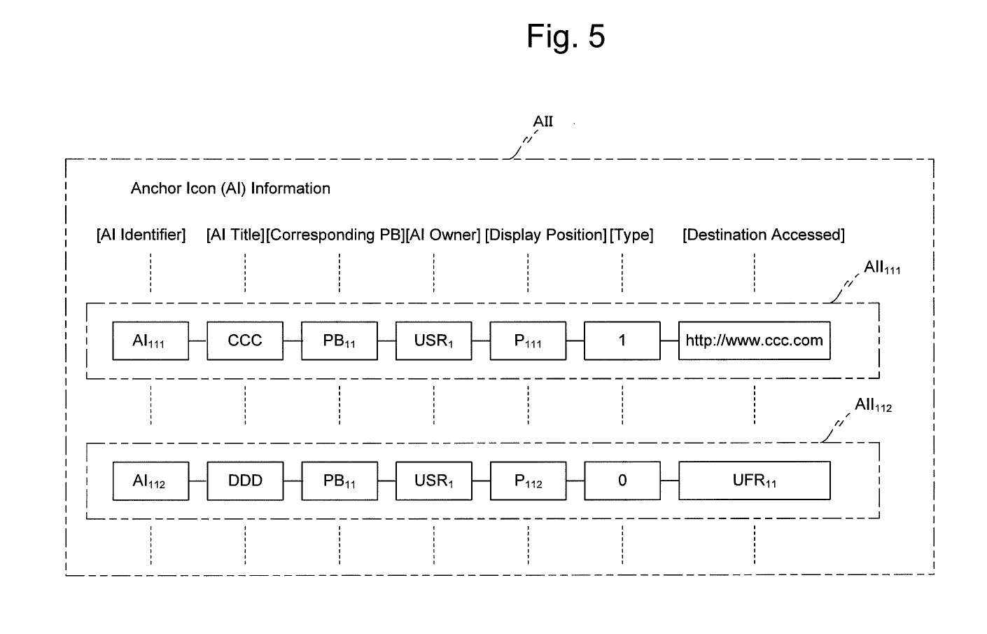

As shown in FIG. 5, individual anchor icon information items AII_{jqr} are included in the anchor icon information AII described above. Here, it is arranged for the corresponding individual items of pinup board information PSI_{jq} to be designated by combinations of the subscript j and the subscript q.

Correspondences, in which the identifiers of the anchor icons (hereinafter abbreviated as “AI” when appropriate) are used as keys, are held in these individual anchor icon information items AII_{jqr} between the AI titles, the corresponding PBs, the AI owners (i.e. their users), their display positions upon the pinup board screens, their types, and their access destinations. Here “type” is an identifier that indicates whether or not the access destination is within the operation support server 20. If “0” is set for the type, then this means that the access destination is within the operation support server 20, and that one of the user files UFRₜ described above is set as the corresponding access destination. Moreover, if “1” is set for the type, then this means that the access destination is a conventional website, and that a URL in the normal format is set as the corresponding access destination. In the following description, an access destination for which the “type” is “0” will be termed an “internal URL”, while an access destination for which the “type” is “1” will be termed an “external URL”.

It should be understood that the pinup board information includes of the pinup board summary information PSI and the anchor icon information AII.

Returning to FIG. 3, during information communication by the processing part 21 via the internet 50, the communication part 23 discussed above functions as an interface between the processing part 21 and the internet 50. When this communication part 23 receives data for transmission from the processing part 21, it sends out this data for transmission to the internet 50. Moreover, when the communication part 23 receives data from the internet 50, it sends this received data to the processing part 21.

Next, the structure of the processing part 21 described above will be explained. This processing part 21 comprises an edit information return part 26, and a pinup board information updating part 27 that serves as an updating part for the pinup board information. Moreover, the processing part 21 comprises a pinup board information return part 28 that serves as a pinup board screen information return part, and an access request processing part 29.

The edit information return part 26 discussed above receives an editing request PER that has been sent from a client terminal device 10ⱼₖ via the internet 50 and the communication part 23. Upon receipt of this editing request PER, the edit information return part 26 generates edit information ESI by referring to the pinup board summary information PSI, the anchor icon information AII, and so on. The edit information return part 26 returns this edit information ESI that it has generated to the client terminal device 10ⱼₖ that issued the edit request, via the communication part 23 and the internet 50.

The pinup board information updating part 27 receives the result of editing ERD that has been sent from the client terminal device 10ⱼₖ via the internet 50 and the communication part 23. Upon receipt of this result of editing ERD, the pinup board information updating part 27 updates the contents of the pinup board summary information PSI and of the anchor icon information AII to contents corresponding to the result of editing ERD.

Next, the pinup board information updating part 27 refers to the pinup board summary information PSI and the anchor icon information AII after updating, and creates pinup board screen display information PAD that reflects the result of editing ERD. Via the communication part 23 and the internet 50, the pinup board information updating part 27 returns the display information PAD that it has thus created to the client terminal device 10ⱼₖ that transmitted the above result of editing ERD.

The pinup board information return part 28 that serves as a pinup screen information return part described above receives the pinup board screen display information request PBR that was sent from the client terminal device 10ⱼₖ via the internet 50 and the communication part 23, as described above. Upon receipt of this display information request PBR, the pinup board information return part 28 refers to the pinup board summary information PSI and to the anchor icon information AII, and creates pinup board screen display information PAD. Then, via the communication part 23 and the internet 50, the pinup board information return part 28 returns this display information PAD that it has created to the client terminal device 10ⱼₖ that transmitted the above display information request PBR.

The access request processing part 29 described above receives the access request ARQ₀ that has been sent from the client terminal device 10ⱼₖ via the internet 50 and the communication part 23. Upon receipt of this access request ARQ₀, the access request processing part 29 reads the content of the user file that is designated in that access request ARQ₀, and returns the result of this reading as content data CTD to the client terminal device 10ⱼₖ that issued the above access request ARQ₀, via the communication part 23 and the internet 50.

### [Operation]

Next, the operation of the operation support system 100 having the structure described above will be explained, with attention being principally directed to the editing of the pinup board information. It should be understood that the editing of the pinup board information of which an explanation will be provided hereinafter is a procedure that is performed using the client terminal device 10₁₂.

When log-in operational input to the operation support server 20 is performed by the user of the client terminal device 10₁₂ by specifying a user name (USR₁) and a password, this log in information is sent from the client terminal device 10₁₂ to the operation support server 20. Upon receipt of this log-in information, the operation support server 20 refers to the pinup board summary information PSI using this user name (USR₁) as a key, and extracts the individual items of pinup board information PSI_{1q} (where q=1, . . . ) for which this user name (USR₁) is registered as the PB owner.

Next, the operation support server 20 generates home screen display information on the basis of these individual items of pinup board information PSI_{1q} (where q=1, . . . ) that have thus been extracted. And the operation support server 20 sends this display information that has been generated to the client terminal device 10₁₂. As a result, upon receipt of this home screen display information, a home screen is displayed by the client terminal device 10₁₂ on its display part 13.

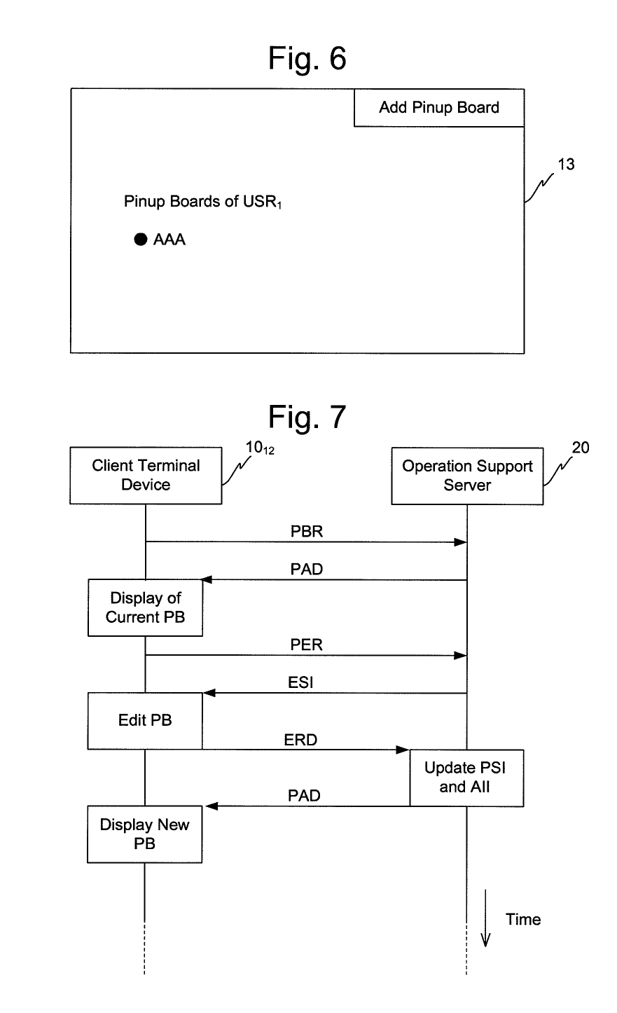

An example of a home screen that has been displayed in this manner is shown in FIG. 6. It should be understood that, in FIG. 6, an example is shown in which only the one individual item of pinup board information PSI₁₁ shown in FIG. 4 above has been extracted, and in which, as names of pinup boards, only a single pinup board “AAA” that the user (USR₁) possesses is displayed.

When operational input is performed of a command to display a pinup board screen for the single pinup board that is being shown upon this home screen, then the pinup board request part 18 of the client terminal device 10₁₂ sends a pinup board screen display information request PBR to the operation support server 20 (refer to FIG. 7). Upon receipt of this display information request PBR, the pinup board information return part 28 of the operation support server 20 refers to the pinup board summary information PSI and to the anchor icon information AII, and creates pinup board screen display information PAD for the pinup board for which the display command has been issued. The operation support server 20 sends this display information PAD that has been created to the client terminal device 10₁₂ (refer to FIG. 7).

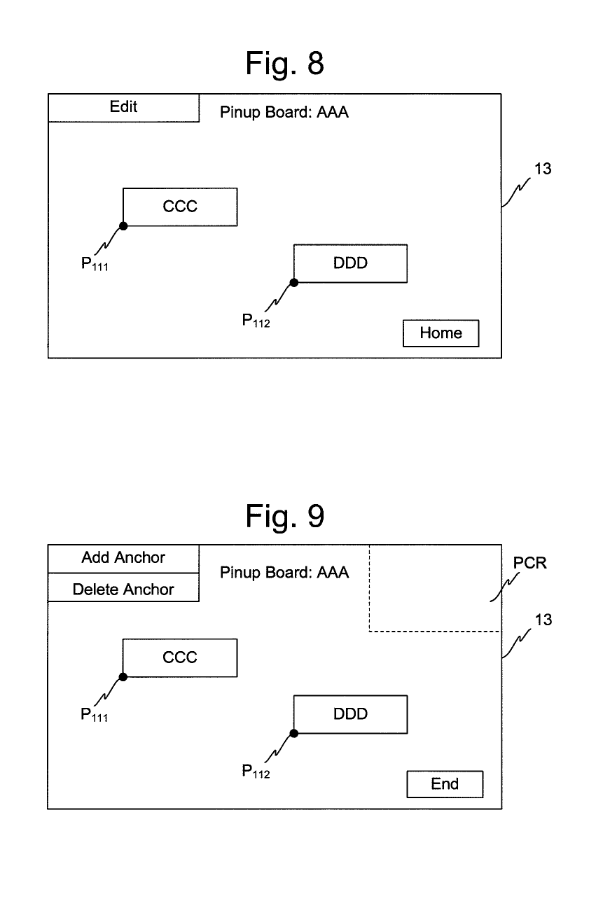

Upon receipt of this display information PAD, a pinup board screen for the pinup board for which the display command was issued is displayed upon the display part 13 by the web access part 19 of the client terminal device 10₁₂. An example of a pinup board screen that has been displayed in this manner is shown in FIG. 8. It should be understood that in FIG. 8 a pinup board screen is shown in which a display command for the pinup board “AAA” in FIG. 6 described above has been issued, display information PAD has been generated on the basis of the individual item of pinup board information PSI₁₁ and on the basis of individual anchor icon information items AII₁₁₁ and AII₁₁₂, so that, along with an anchor icon “CCC” being displayed in the position P₁₁₁, also an anchor icon “DDD” is displayed in the position P₁₁₂.

<Pinup Board Information Editing Processing Related to a Pinup Board that already Exists>

Next, the processing will be explained for editing pinup board information corresponding to a pinup board screen displayed as described above (i.e., the processing for editing pinup board information related to a pinup board that already exists).

This type of editing processing of pinup board information relating to a pinup board that already exists is started by operational input of an editing start command for pinup board information corresponding to a pinup board screen that is displayed upon the display part 13. When operational input of this editing start command is performed, the client terminal device 10₁₂ sends an edit request PER for the pinup board information to the operation support server 20 (refer to FIG. 7). Upon receipt of this edit request PER, the operation support server 20 refers to the pinup board summary information PSI and to the anchor icon information AII, and generates edit information ESI for the pinup board for which this editing start command was issued. The operation support server 20 returns this edit information ESI that it has thus generated to the client terminal device 10₁₂ (refer to FIG. 7).

Upon receipt of this edit information ESI, an initial editing screen for the pinup board for which the editing start command has been issued is displayed by the client terminal device 10₁₂ upon its display part 13. An example of an initial editing screen that has been displayed in this manner is shown in FIG. 9. It should be understood that, in FIG. 9, an example is shown of an initial editing screen when, during the display of the pinup board screen of FIG. 8 described above, an editing start command has been issued for pinup board information that corresponds to that pinup board screen.

Subsequently, editing of the pinup board information is performed according to operational input of editing commands to the operation input part 12.

### <<Editing the Display Positions of Anchor Icons>>

First, the editing of the display position of an anchor icon will be explained.

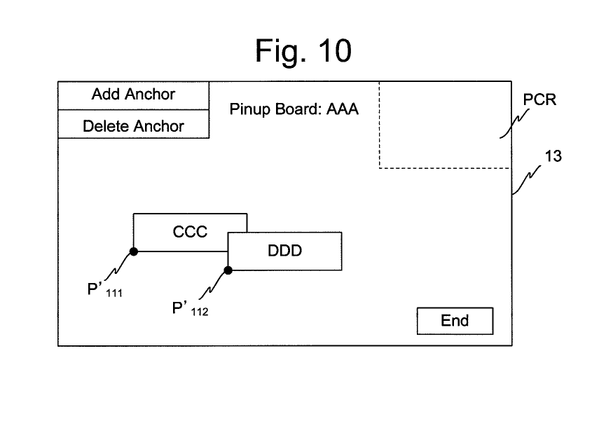

The editing of the display position of an anchor icon may, for example, be executed by using a mouse that is provided to the operation input part 12, and by performing actuation to drag the anchor icon that is to be the subject for change of its display position. In the case of this embodiment, in order to make it possible to perform this dragging operation, it is arranged to display an initial editing screen upon which a program written in Javascript handles the edit information ESI. An example of an editing screen when the display positions of anchor icons have been changed in this manner is shown in FIG. 10.

In FIG. 10 an editing screen is shown when, from the state of the initial editing screen of FIG. 9 described above, along with shifting the display position of the anchor icon “CCC” to a position P′₁₁₁, also the display position of the anchor icon “DDD” has been shifted to a position P′₁₁₂. It should be understood that, when shifting these anchor icons, the anchor icons that have become the subjects of being shifted may be shifted to any desired positions that the user may select.

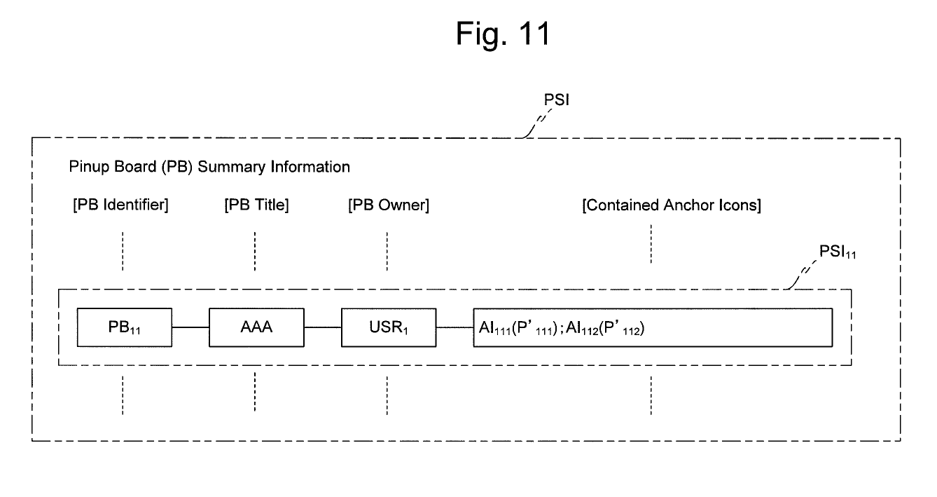

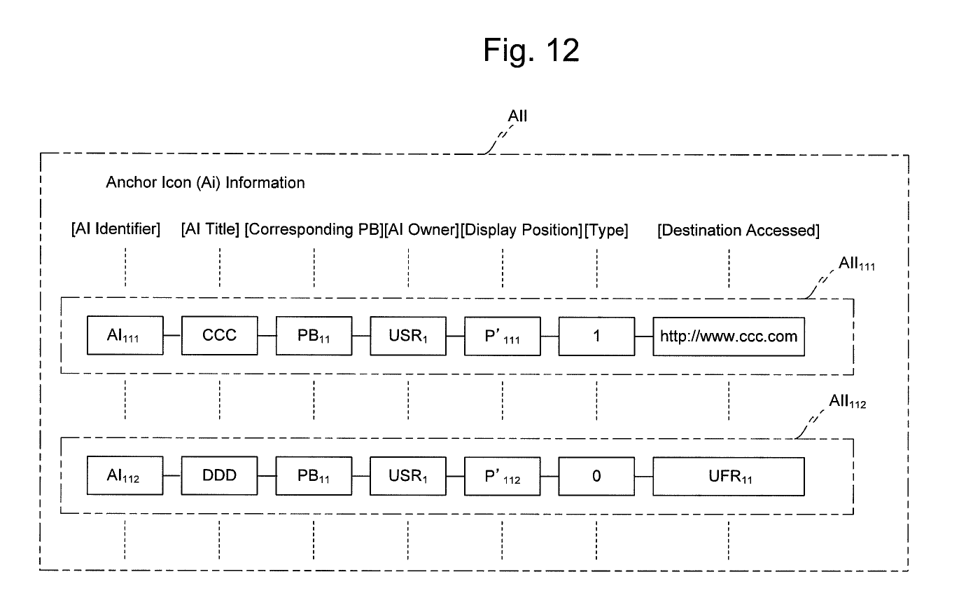

When an editing end command is inputted to the operation input part 12 after one or more anchor icons have been shifted upon the editing screen in this manner, the pinup board editing part 17 of the client terminal device 10₁₂ sends the result of shifting the display positions of the anchor icons to the operation support server 20 as the result of editing ERD (refer to FIG. 7). Upon receipt of this result of editing ERD, the pinup board information updating part 27 of the operation support server 20 updates the contents of the pinup board summary information PSI and the contents of the anchor icon information AII to contents corresponding to the result of editing ERD. Examples of the pinup board summary information PSI and the anchor icon information AII that have been updated in this manner are shown in FIGS. 11 and 12. It should be understood that, in FIGS. 11 and 12, examples are shown for when updating has been performed to reflect the shifting of the display positions of the anchor icons shown in FIG. 10 described above.

Next, the pinup board information updating part 27 of the operation support server 20 refers to the pinup board summary information PSI and to the anchor icon information AII after editing, and creates pinup board screen display information PAD for the pinup board that was the subject of editing. The operation support server 20 returns this display information PAD that has thus been created to the client terminal device 10₁₂ (refer to FIG. 7).

Upon receipt of this display information PAD, a pinup board screen after editing for the pinup board that has been the subject of editing is displayed by the client terminal device 10₁₂ upon its display part 13. An example of a pinup board screen that has been displayed in this manner is shown in FIG. 13.

### <<Editing to Add and to Delete Anchor Icons>>

Next, editing to add and to delete anchor icons will be explained.

The processing starts by an anchor icon add command being inputted to the operation input part 12 during the display of the initial editing screen that has been displayed as described above. It should be understood that FIG. 14 shows an example of the editing screen at the time point that an anchor icon add command is inputted to the operation input part 12, while the initial editing screen shown in FIG. 9 described above is being displayed.

When this anchor icon add command is inputted, the client terminal device 10₁₂ sends to the operation support server 20 an edit request PER, which is a screen display information request for specification of the title and the type of the new anchor icon (refer to FIG. 7). Upon receipt of this edit request PER, the edit information return part 26 of the operation support server 20 generates screen display information for specification of the title and the type of the new anchor icon, and returns this screen display information to the client terminal device 10₁₂ that issued the edit request as edit information ESI, via the communication part 23 and the internet 50 (refer to FIG. 7).

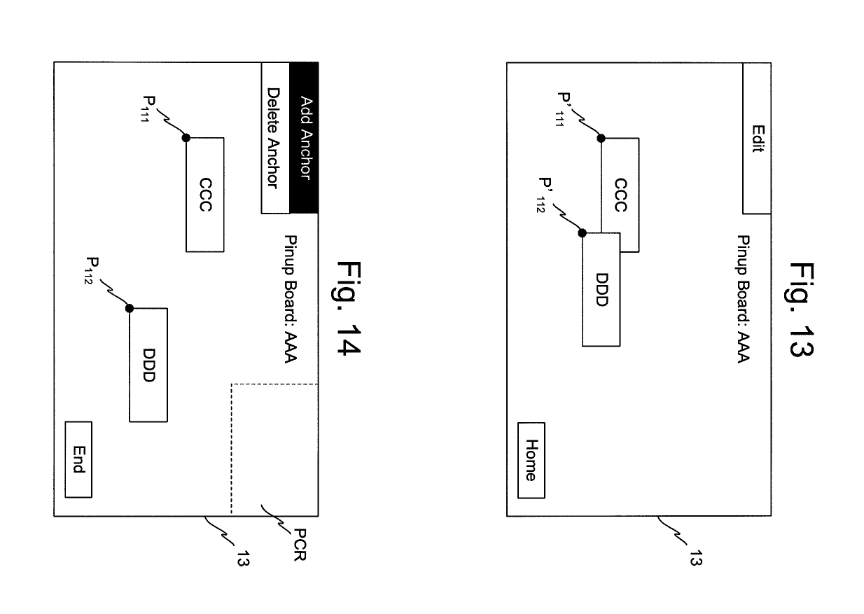

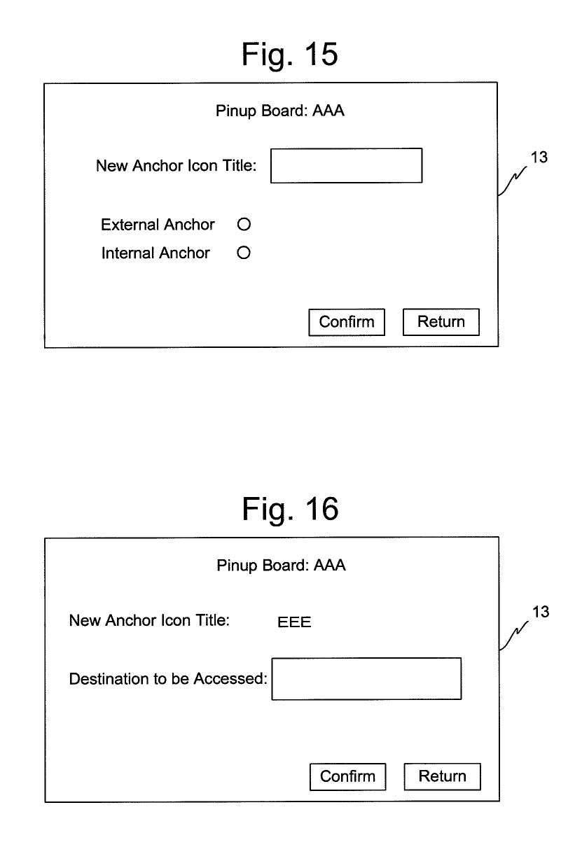

The pinup board editing part 17 receives this edit information ESI that has been returned from the operation support server 20 as a response to the edit request PER via the internet 50 and the communication part 14. The pinup board editing part 17 sends to the display part 13 display information for a screen for specification of the title and the type of the new anchor icon, which is the above edit information ESI. As a result, a screen for specification of the title and the type of the new anchor icon is displayed upon the display part 13. An example of such a screen for specification of the title and the type of a new anchor icon is shown in FIG. 15.

The title and the type of the new anchor icon are then inputted using the operation input part 12. At this time, if “external anchor” is selected as the type and also a title for this new anchor icon has been inputted, then the pinup board editing request part 16 of the client terminal device 10₁₂ sends a request for screen display information for specification of an access destination to the operation support server 20 via the communication part 14 and the internet 50, as an edit request PER in which the new anchor icon title is specified (refer to FIG. 7).

In the operation support server 20, the edit information return part 26 receives this screen display information request for specification of an access destination. Next, as edit information ESI, the edit information return part 26 generates screen display information for specification of an access destination to correspond to this anchor icon that has been specified. The edit information return part 26 returns this edit information ESI that has thus been created to the client terminal device 10₁₂ that issued the edit request, via the communication part 23 and the internet 50.

In the client terminal device 10₁₂, the pinup board editing part 17 receives this edit information ESI that has been returned from the operation support server 20. The pinup board editing part 17 sends screen display information for designation of an access destination to correspond to the new anchor icon title to the display part 13. As a result, a screen for designation of an access destination is displayed upon the display part 13. An example of such a screen for designation of an access destination is shown in FIG. 16. It should be understood that, in FIG. 16, an example is shown for a case in which “EEE” has been inputted on the screen of FIG. 15 described above as the title for the new anchor icon.

When, in the state in which the above described screen for specification of an access destination is being displayed, the URL of an access destination has been inputted by the user via the operation input part 12; and when an edit end command for creating the new anchor icon is inputted, the pinup board editing part 17 of the client terminal device 10₁₂ sends the result of editing by addition of this anchor icon to the operation support server 20 as the result of editing ERD. In this case, the pinup board editing part 17 sends the title “EEE” of the new anchor icon and the access destination URL that have been inputted to the operation support server 20 as the result of editing ERD (refer to FIG. 7). This result of editing ERD is received by the pinup board information updating part 27 in the operation support server 20. Then, the pinup board information updating part 27 updates the contents of the pinup board summary information PSI and the contents of the anchor icon information AII so that they become contents corresponding to this result of editing ERD.

Moreover, if, on the screen of FIG. 15 described above, an editing end command for creating a new anchor icon is inputted after “internal anchor” has been designated as the type and also a title for this new anchor icon has been inputted, then the pinup board editing part 17 sends the title for the new anchor icon and the type information (“internal anchor”) for this anchor icon as the result of editing ERD to the operation support server 20 via the communication part 14 and the internet 50 (refer to FIG. 7). Upon receipt of this result of editing ERD, the pinup board information updating part 27 of the operation support server 20 updates the contents of the pinup board summary information PSI and the contents of the anchor icon information AII so that they become contents corresponding to this result of editing ERD. At this time, the pinup board information updating part 27, along with adding the new anchor icon information to the pinup board summary information PSI and to the anchor icon information AII, also automatically newly creates a user file corresponding to this new anchor information within the user file region UFR.

Subsequently, the pinup board information updating part 27 refers to the pinup board summary information PSI and to the anchor icon information AII after updating, and generates pinup board screen display information PAD for the pinup board that is the subject of editing. The operation support server 20 returns this display information PAD that has thus been created to the client terminal device 10₁₂ (refer to FIG. 7).

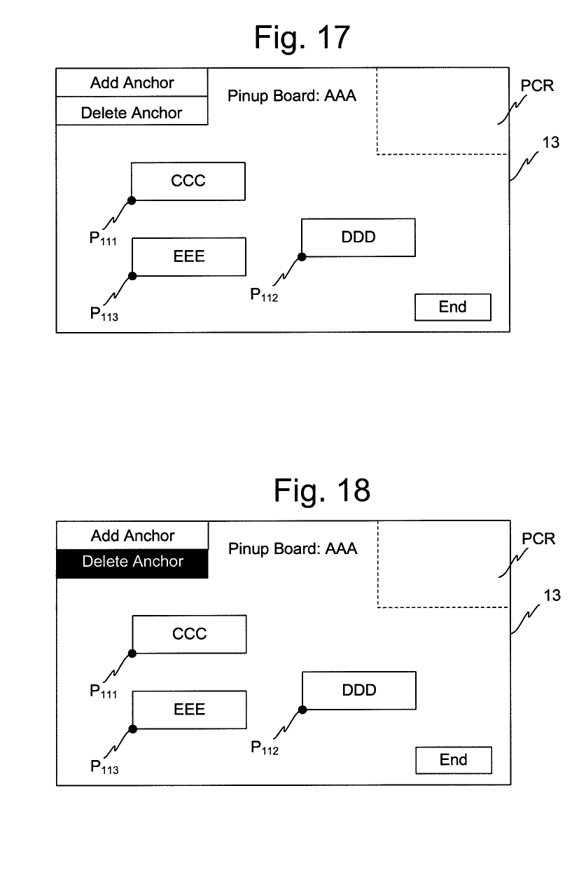

A pinup board screen to which the new anchor icon is added is then displayed upon the display part 13 by the client terminal device 10₁₂ that has received this display information PAD. Thereafter, in the client terminal device 10₁₂, an editing start command is issued on the pinup board screen, and edit information ESI sent from the operation support server 20 in response to this editing start command is received. On the basis of this edit information ESI, an initial editing screen for the pinup board for which this start command has been issued is displayed by the client terminal device 10₁₂ upon the display part 13. An example of such an editing screen to which a new anchor icon has been added is shown in FIG. 17. It should be understood that, in FIG. 17, an example is shown for when the new anchor icon “EEE” has been added to the editing screen of FIG. 9 described above.

Here, while the display position for this anchor icon “EEE” is some prearranged position that is determined in advance for initial addition of an anchor icon (for example, the position at the center of the screen), since, in the case of this embodiment, a program that is written in Javascript is provided to the edit information ESI for the pinup board as well, in order to enable dragging operation to be performed. Accordingly, the user is able to shift this anchor icon to any desired position by performing similar operation to the case described above of editing the display position of an anchor icon. In FIG. 17, an example is shown of a case in which the display position for the anchor icon “EEE” is the position P₁₁₃.

Editing for deletion of an anchor icon is started by an anchor icon delete command being inputted to the operation input part 12 (refer to FIG. 18). When such editing for deletion of an anchor icon is started, it is arranged for the client terminal device 10₁₂ to send a request to the operation support server 20 for screen information for anchor icon deletion. Upon receipt of this request, the edit information return part 26 of the operation support server 20 creates screen display information for anchor icon deletion, and returns it as edit information ESI to the client terminal device 10₁₂ that issued the request via the communication part 23 and the internet 50 (refer to FIG. 7).

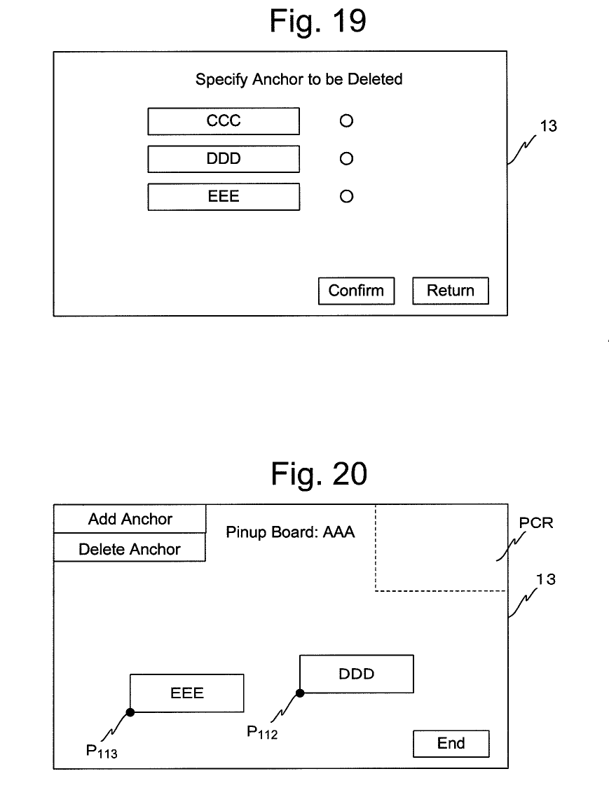

In the client terminal device 10₁₂, the pinup board editing part 17 receives this edit information ESI. The pinup board editing part 17 sends screen display information for anchor icon deletion, which is this edit information ESI, to the display part 13. As a result, a screen for deletion of the anchor icon is displayed upon the display part 13. Anchor icons that are candidates for deletion are displayed upon this screen for deletion as a list. An example of such a screen for deletion of an anchor icon is shown in FIG. 19.

Next, when, in the state in which this screen for deletion of an anchor icon is displayed, a command for selection of an anchor icon that is to become the subject for deletion and a command for confirmation of that selection are inputted to the operation input part 12, the pinup board editing part 17 sends a message to this effect to the operation support server 20 as a result of editing ERD (refer to FIG. 7). When the pinup board information updating part 27 of the operation support server 20 receives this result of editing ERD, it updates the contents of the pinup board summary information PSI and the contents of the anchor icon information AII to contents corresponding to this result of editing ERD. Subsequently, the pinup board information updating part 27 refers to the pinup board summary information PSI and the anchor icon information AII after updating, and creates pinup board screen display information PAD for the pinup board that is to be the subject of editing. The operation support server 20 returns this display information PAD that has thus been created to the client terminal device 10₁₂ (refer to FIG. 7).

It should be understood that, if the anchor icon that has become the subject for deletion is an “internal anchor”, then the pinup board information updating part 27, along with deleting the anchor information corresponding to this anchor icon that has become the subject for deletion from the pinup board summary information PSI and the anchor icon information AII, also automatically deletes the user file that corresponds to information for this anchor icon that has become the subject for deletion from within the user file region UFR.

An example of an editing screen upon which an anchor icon that has become the subject for deletion has been deleted by the client terminal device 10₁₂ that has received this display information PAD is shown in FIG. 20. It should be understood that, in FIG. 20, an example is shown of an editing screen after, from the state of the editing screen of FIG. 17 described above, the anchor icon “CCC” that is to be taken as the subject of deletion has been selected, and has further been deleted.

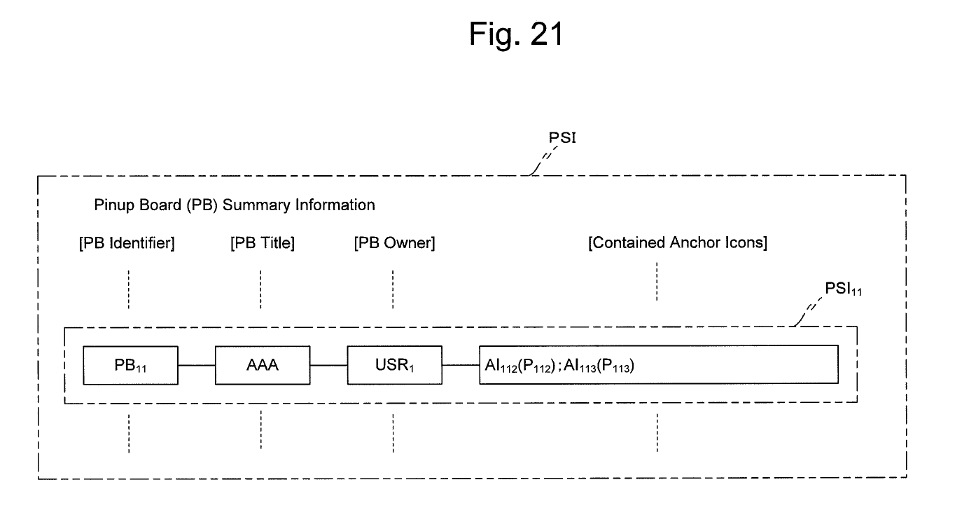

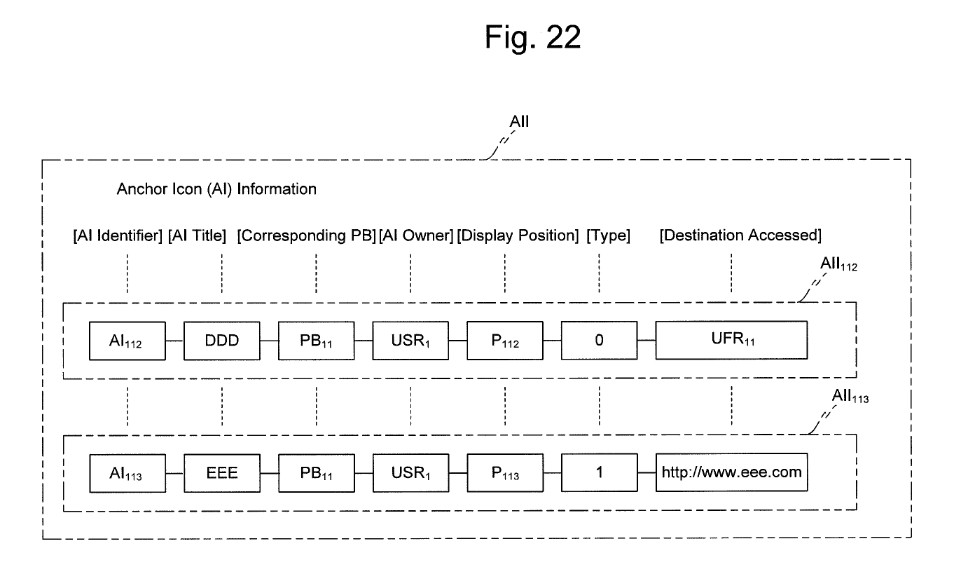

Examples of pinup board summary information PSI and anchor icon information AII that have been updated along with addition or deletion of an anchor icon that has been performed in this manner are shown in FIGS. 21 and 22. It should be understood that in FIGS. 21 and 22, there is shown an example of a case in which the anchor icon addition and deletion explained with reference to the above FIGS. 14 through 20 have been performed.

### <<Editing to Create a Lower Level Pinup Board>>

Next, editing to create a lower level pinup board will be explained.

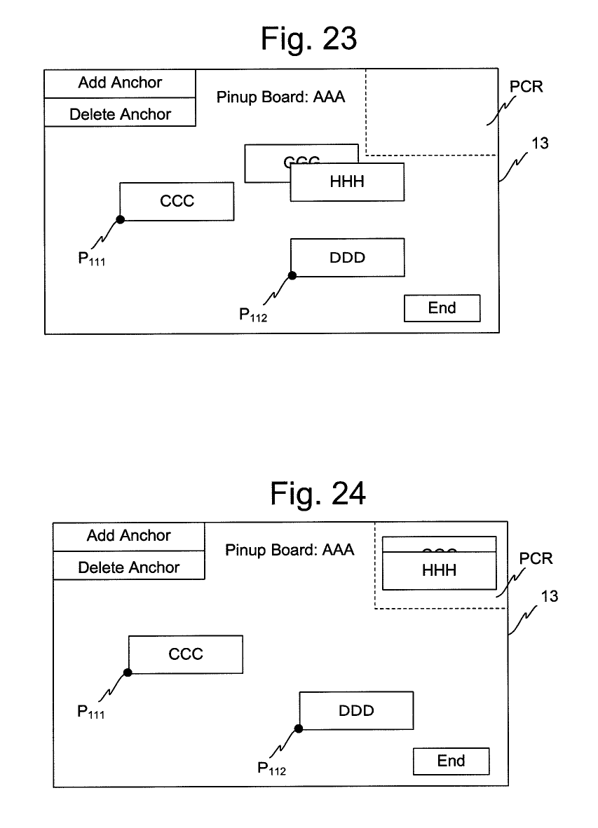

In a case such as that shown in FIG. 23 in which too many anchor icons would result from the addition of an anchor icon as described above, or the like, then editing is performed for creation of a pinup board at a lower level. It should be understood that, in FIG. 23, an editing screen is shown for the case in which, from the state of FIG. 9 as described above, anchor icons “GGG” and “HHH” have been added.

First, during this editing to create a lower level pinup board, actuation is performed (for example using a mouse that is provided to the operation input part 12) so as to drag an anchor icon that is to be displayed upon a pinup board screen at a lower level, and so as to shift this icon to a predetermined region PCR upon the editing screen (refer to FIG. 24). It should be understood that, in FIG. 24, an example is shown in which the anchor icons that are to be displayed upon the pinup board screen at a lower level are the anchor icon “GGG” and the anchor icon “HHH”.

Subsequently, processing for creating a pinup board upon a lower level is started when the fact that a command for the end of editing of the pinup board (PB) by the user has been inputted is notified from the operation input part 12. During this processing, first, as a result of editing ERD, the pinup board editing part 17 sends the identifier of the anchor icon and the display position of this anchor icon to the operation support server 20, via the communication part 14 and the internet 50.

In the operation support server 20, the edit information return part 26 receives this result of editing ERD. On the basis of the display position of the anchor icon that is included in this result of editing ERD, the edit information return part 26 separates out the identifier(s) of the anchor icon or icons that have been shifted to the predetermined region PCR from the identifiers of the anchor icon or icons that are outside this predetermined region PCR. Next, via the communication part 23 and the internet 50, the edit information return part 26 transmits to the client terminal device 10ⱼₖ, as edit information ESI, information for displaying a screen for specification of the title of a new pinup board, in which is embedded information about the identifier(s) of the anchor icon or icons that have been shifted to the predetermined region PCR, and information about the identifier(s) of the other anchor icon or icons that are outside the predetermined region PCR.

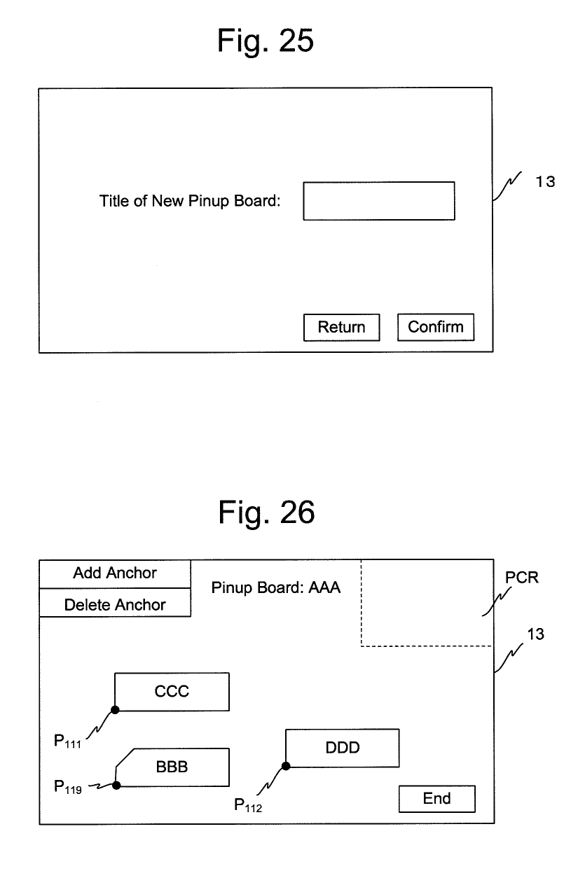

Upon receipt from the operation support server 20 of this information for displaying a screen for specification of the title of the new pinup board, the processing part 11 of the client terminal device 10₁₂ sends this information to the display part 13, so that the display part 13 displays a screen for specifying of the title of the new pinup board. An example of such a screen for specification of the title of a new pinup board is shown in FIG. 25.

When a title for the new pinup board has been inputted by using the operation input part 12, the pinup board editing part 17 transmits to the operation support server 20, via the communication part 14 and the internet 50, as a result of editing ERD, information about the identifier(s) of the anchor icon or icons that have been shifted to the predetermined region PCR, information about the identifier(s) of the anchor icon or icons that are outside this predetermined region PCR, and the title of the new pinup board.

In the operation support server 20, the pinup board information updating part 27 receives this result of editing ERD. The pinup board information updating part 27 updates the contents of the pinup board summary information PSI and the contents of the anchor icon information AII to contents corresponding to this result of editing ERD.

During this updating, a pinup board on a lower level is newly created, and it is arranged for the anchor icon or icons that were shifted to the predetermined region PCR to be associated with this lower level pinup board. On the other hand, along with the deletion of this anchor icon or icons that now belong to this lower level pinup board that has newly been created from the pinup board on the higher level that was the source for creation of this lower level pinup board, an icon corresponding to the lower level pinup board is also added to this pinup board.

Next, the pinup board information updating part 27 refers to the pinup board summary information PSI and to the anchor icon information AII after updating, and creates pinup board screen display information PAD for the higher level pinup board that was the subject of editing. The pinup board information updating part 27 returns this display information PAD that it has created to the client terminal device 10₁₂ (refer to FIG. 7).

Upon receipt of this display information PAD, the client terminal device 10₁₂ displays a higher level pinup board after editing screen for the pinup board that was the subject of editing upon the display part 13. An example of an editing screen corresponding to a higher level pinup board that has been displayed in this manner is shown in FIG. 26. It should be understood that, in FIG. 26, an example is shown in which “BBB” has been specified as the title of the lower level pinup board that was newly created.

Here, while the display position for the pinup board icon “BBB” when the pinup board at the lower level is initially created is a predetermined position (for example, at the central portion of the screen) that is determined in advance, it is arranged for it to be possible for the user to shift this icon to any desired position, in a similar manner to the case during the above described anchor icon display position editing. In FIG. 26, an example is shown of a case in which the display position for the pinup board icon “BBB” is a position P₁₁₉.

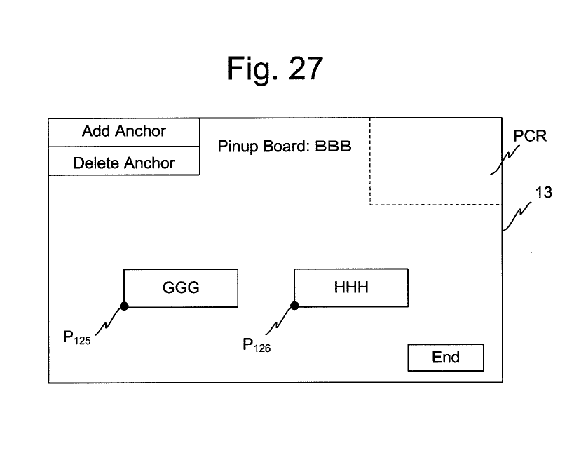

Moreover, in FIG. 27, an example is shown of an editing screen that relates to a pinup board at a lower level. Here, while the display position for the anchor icon for the lower level pinup board screen when the pinup board at the lower level is initially created is a predetermined position (for example, at the central portion of the screen) that is determined in advance, it is arranged for it to be possible for the user to shift this icon to any desired position, in a similar manner to the case during the above described anchor icon display position editing. In FIG. 27, an example is shown of a case in which the display position for a pinup board “GGG” is a position P₁₂₅ and the display position for a pinup board “HHH” is a position P₁₂₆.

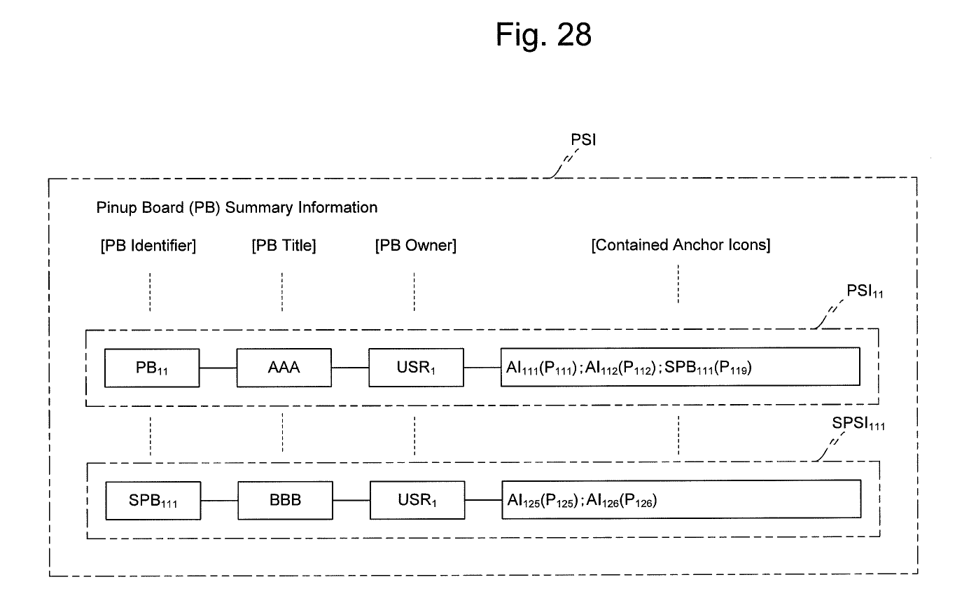

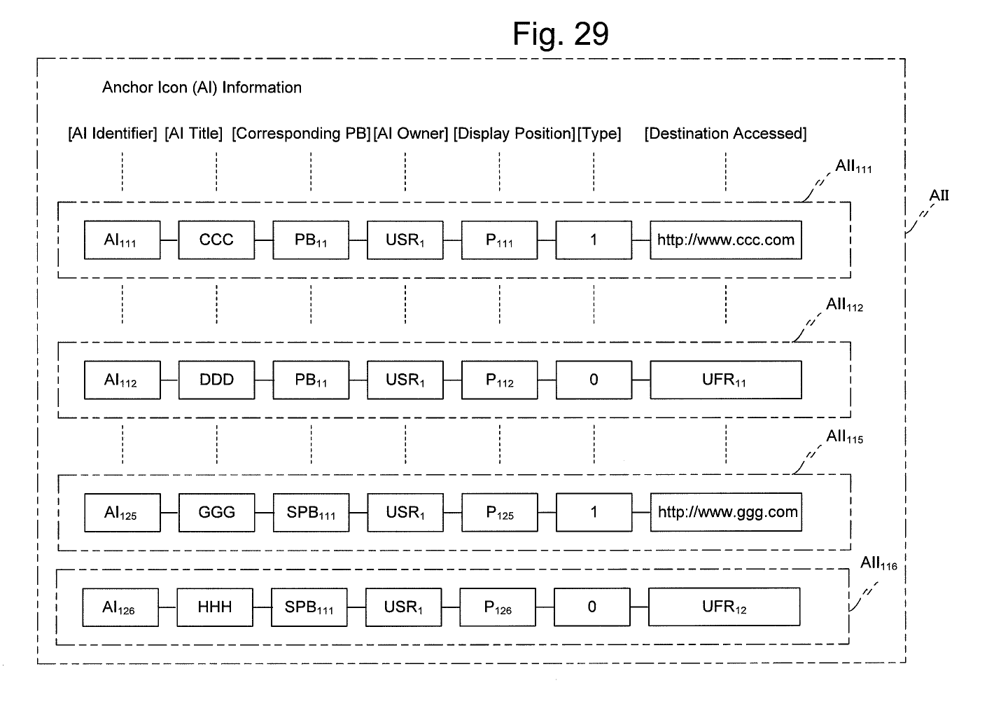

Examples of pinup board summary information PSI and anchor icon information AII after a lower level pinup board has been created in this manner are shown in FIGS. 28 and 29. It should be understood that, in FIGS. 28 and 29, there are shown examples for a case in which the creation of a lower level pinup board explained with reference to the above FIGS. 23 through 27 has been performed.

### <Editing to Add a Pinup Board at the Highest Level>

Next, editing to add a pinup board at the highest level will be explained.

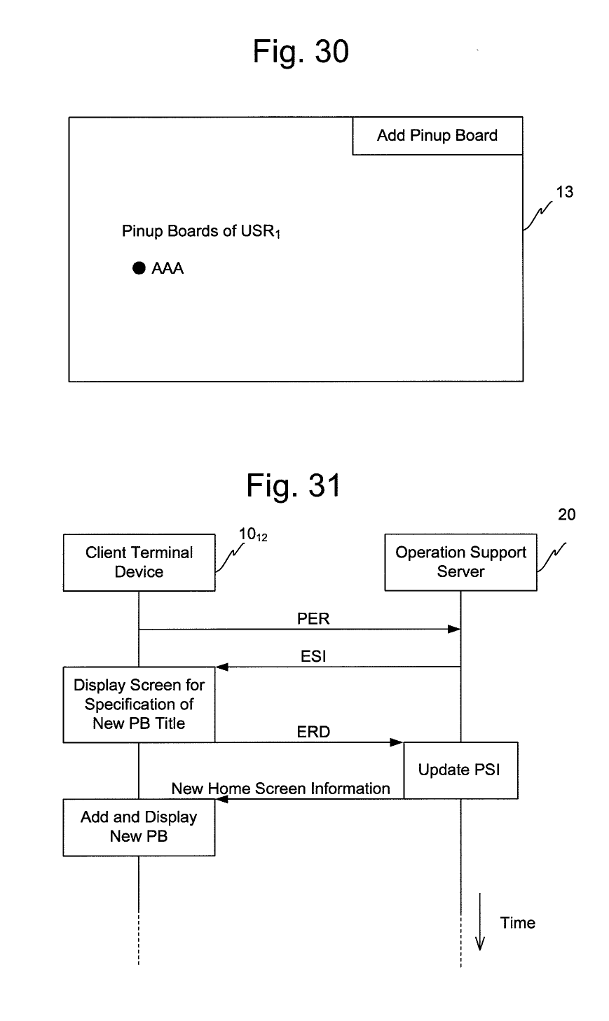

Editing to add a pinup board at the highest level is started by an add command for a pinup board at the highest level being inputted to the operation input part 12 during display of the home screen shown in FIG. 30, which is a repetition of FIG. 6 described above. When this add command for a pinup board at the highest level is inputted, the client terminal device 10₁₂ sends to the operation support server 20 an edit request PER which specifies that it is a request for addition of a pinup board at the highest level (refer to FIG. 31). Upon receipt of this edit request PER, the operation support server 20 creates edit information ESI for adding a pinup board at the highest level. Moreover, the operation support server 20 returns this edit information ESI that it has created to the client terminal device 10₁₂ (refer to FIG. 31).

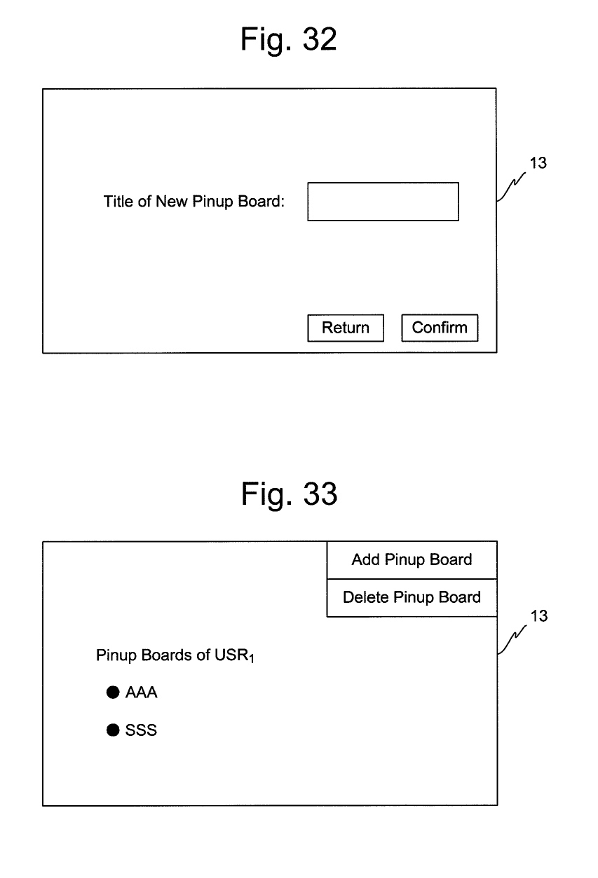

Upon receipt of this edit information ESI, a screen for specification of a title for the new pinup board that is to be added is displayed by the client terminal device 10₁₂ upon its display part 13. An example of such a screen that is displayed for specifying the title of the new pinup board is shown in FIG. 32.

When a title is inputted for the new pinup board by using the operation input part 12, the client terminal device 10₁₂ sends this input result to the operation support server 20 as a result of editing ERD (refer to FIG. 31). Upon receipt of this result of editing ERD, the pinup board information updating part 27 in the operation support server 20 updates the contents of the pinup board summary information PSI to contents that correspond to this result of editing ERD. Here, the reason that only the contents of the pinup board summary information PSI is updated but updating of the contents of the anchor icon information AII is not performed, is because, when a new pinup board is being added as a pinup board at the highest level, no anchor icon exists that is related to this new pinup board.

Next, the operation support server 20 refers to this updated pinup board summary information PSI, and creates new home screen information. The operation support server 20 sends this new home screen information that has been created to the client terminal device 10₁₂ (refer to FIG. 31). Upon receipt of this new home screen information, a new home screen based upon this new home screen information is displayed upon the display part 13 by the client terminal device 10₁₂. An example of a new home screen that is displayed in this manner is shown in FIG. 33.

It should be understood that, in FIG. 33, an example is shown for a case in which the title of the new pinup board at the highest level that has been added is “SSS”.

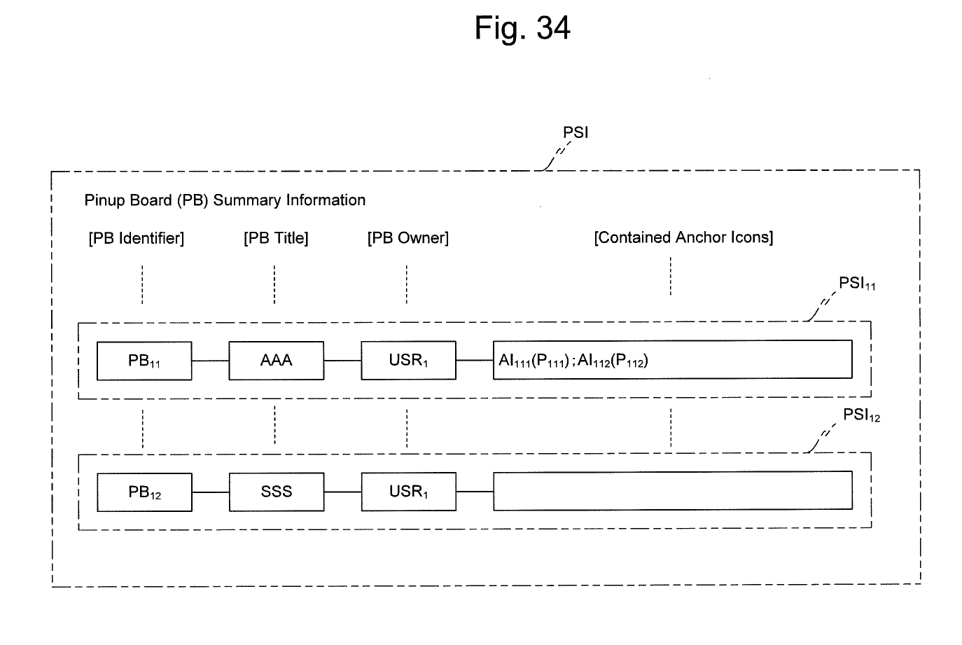

An example is shown in FIG. 34 of pinup board summary information PSI that has been updated by adding the pinup board “SSS” as a pinup board at the highest level as described above.

It should be understood that, during display of the home screen, it is possible to delete a pinup board that is designated for deletion by designating the pinup board that is to be the subject for deletion from among the pinup boards that are displayed upon the home screen. In this case, if an anchor icon exists related to the pinup board that is designated for deletion, then both its pinup board summary information PSI and its anchor icon information AII are updated.

Moreover, editing of pinup board information that is utilized by any client terminal device 10ⱼₖ other than this client terminal device 10₁₂ may be performed in a similar manner to that described above.

### <Perusal of Content>

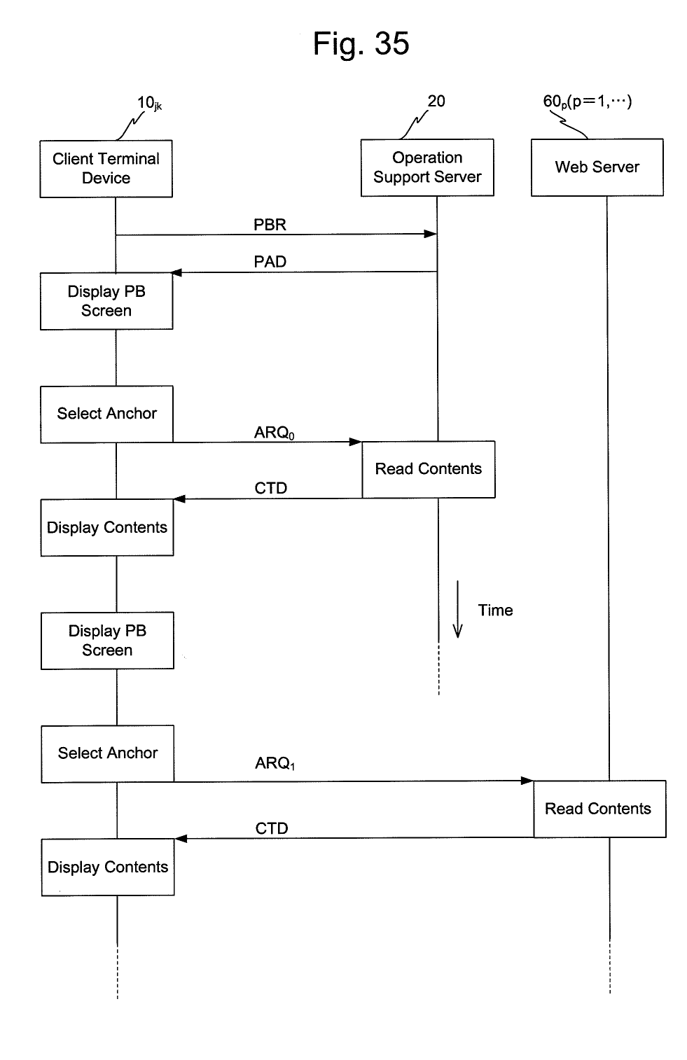

Next, perusal of content by a client terminal device 10ⱼₖ (where j=1, . . . and k=1, . . . ) using the operation support server 20 will be explained with reference to FIG. 35.

When perusal of content is to be performed using the operation support server 20, first the client terminal device 10ⱼₖ performs log-in processing to the operation support server 20. In this log-in processing, as described above for the client terminal device 10₁₂, log-in operational input is performed by specifying a user name and a password. As a result, a home screen that includes a list display of pinup boards is displayed upon the display part 13 of the client terminal device 10ⱼₖ.

When operational input is performed of a pinup board screen display command for one of the pinup boards that is being displayed upon this home screen, the client terminal device 10ⱼₖ sends a pinup board screen display information request PBR to the operation support server 20. Upon receipt of this display information request PBR by the operation support server 20, the pinup information return part 28 thereof refers to the pinup board summary information PSI and to the anchor icon information AII, and creates pinup board screen display information PAD for the pinup board for which the display command was issued. The operation support server 20 returns this display information PAD that has been created to the client terminal device 10ⱼₖ that issued the display information request PBR.

Upon receipt of this display information PAD, the pinup board screen for the pinup board for which the display command was issued is displayed by the client terminal device 10ⱼₖ upon its display part 13. When input selection designation is issued by the user of a desired anchor icon that is being displayed upon the displayed pinup board screen, the client terminal device 10ⱼₖ sends out a request ARQ to the internet 50 for access to the access destination corresponding to this designated anchor icon.

Here, if the access destination corresponding to the anchor icon that has been designated is an internal URL that is located within the operation support server 20, then the client terminal device 10ⱼₖ sends an access request ARQ₀ to the operation support server 20. Upon receipt of this access request ARQ₀, the operation support server 20 reads the content data stored in the user file that is designated in the access request ARQ₀. Then, the operation support server 20 sends the result of this reading to the client terminal device 10ⱼₖ that issued the access request ARQ₀, as content data CTD. Upon receipt of this content data CTD, the client terminal device 10ⱼₖ creates content data for screen display on the basis of this content data CTD, and sends it to the display part 13. As a result, the content that has been accessed is displayed upon the display part 13 and is presented to the user for perusal.

Moreover, if the access destination corresponding to the anchor icon that has been designated is an external URL, then the client terminal device 10ⱼₖ sends an access request ARQ₁ to that one among the web servers 60ₚ (where p=1, . . . ) in which that external URL is included. Upon receipt of this access request ARQ₁, the web server reads the content data corresponding to the URL that is designated in the access request ARQ₁. Then, the web server sends the result of this reading to the client terminal device 10ⱼₖ that issued the access request ARQ₁, as content data CTD. Upon receipt of this content data CTD, the client terminal device 10ⱼₖ creates content data for screen display on the basis of this content data CTD, and sends it to the display part 13. As a result, the content that has been accessed is displayed upon the display part 13 and is presented to the user for perusal.

As has been explained above, with the operation support system 100 of this embodiment, pinup board information is stored in the storage part 22 of the operation support server 20. For each user of the client terminal devices 10ⱼₖ, the display positions upon pinup board screens of anchor icons, which are anchor symbols each of which corresponds to a destination for access by the user, the identifiers of these anchor icons, and the access destination specifications corresponding to these anchor icons are kept in mutual correspondence by this pinup board information.

Editing of this pinup board information may be performed by each of the client terminal devices 10ⱼₖ. During this editing of the pinup board information, first, as an initial screen, an editing screen is displayed upon the display part 13 reflecting a pinup board screen based upon the pinup board information in the storage part 22 of the operation support server 20. The client terminal device 10ⱼₖ performs editing while changing the display content of the editing screen for the pinup board, according to editing commands that are inputted by the user who issues them while referring to the display upon the display part 13. When the editing ends, the client terminal device 10ⱼₖ sends the result of editing ERD to the operation support server 20. The operation support server 20 updates the pinup board information within the storage part 22 on the basis of this result of editing ERD.

Moreover, when a command for display of a pinup board screen is inputted, the client terminal device 10ⱼₖ sends a pinup board screen display information request PBR to the operation support server 20. The operation support server 20 creates display information for the requested pinup board screen by referring to the pinup information that corresponds to that pinup board screen, and returns the pinup board screen display information PAD that has been created to the client terminal device 10ⱼₖ that issued the request PBR.

The client terminal device 10ⱼₖ displays the pinup board screen upon the display part 13 on the basis of this display information PAD. Subsequently, when a command is inputted for selection of a single anchor icon upon this pinup board screen that is being displayed, access is performed to the access destination that corresponds to this selected anchor icon. As a result, the content at the access destination corresponding to the anchor icon that was selected is offered by the client terminal device 10ⱼₖ to the user for perusal.

Thus, according to the operation support system 100 of this embodiment, even if the user possesses a plurality of client terminal devices, it is possible, by employing pinup board information that is stored in the storage part 22 of the operation support server 20, for him to dispense with the task of maintaining an operating environment on each of these terminal devices for accessing content. Moreover, since the user is able to edit the pinup board information to the details that he desires, accordingly it is possible for him to customize the pinup board screens to a style for which the convenience of use from his point of view is good. Due to this, it is possible to enhance the convenience for the user when he performs operation to access content of various types.

Moreover, in this embodiment, addition of a new anchor icon, changing the display position of at least a single anchor icon that already exists, and deletion of at least a single anchor icon that already exists, are all included in the editing of the pinup board information. Due to this, it is possible to arrange the anchor icons that have been selected by the decision of the user at display positions that are more freely set by the user, so that they are grouped into sets that follow the way of thinking or the conceptualization of the user. Here, when displaying anchor icons, it is possible to group the anchor icons with good efficiency while following the way of thinking of the user, since it is possible to display other anchor icons so as to overlap at least a portion of one anchor icon.

Moreover, in this embodiment, creation is performed of a lower level pinup board including icon information consisting of anchors and relating to at least a single anchor icon that is being displayed upon a pinup board screen. By doing this, if, for example, the number of anchor icons upon a single pinup board screen increases so to become too great, then it is possible to separate these anchor icons upon this single pinup board screen into two groups, while emphasizing the degree of organic correlation between these anchor icons from the point of view of the user.

Moreover, in this embodiment, if a lower level pinup board is to be created, it is arranged, when a pinup board editing end command is inputted by the user after at least a single anchor icon that is being displayed upon the pinup board screen has been shifted to within a predetermined region upon this pinup board editing screen, to create a new lower level pinup board that includes this anchor icon that was shifted to within the predetermined region. Due to this, it is possible to separate anchor icons upon a single pinup board screen between two pinup board screens by an operation that is extremely simple from the point of view of the user.

Moreover, in this embodiment, either an access destination within the operation support server 20, or an access destination within some web server 60₁, . . . other than the operation support server that is connected thereto by the internet 50 can be selected as the access destination corresponding to each one of the anchor icons. Due to this, in addition to the content of a normal website, it is also possible to refer to content specific to each user that has been created by that user, and that is stored within the operation support server 20.

It should be understood that the embodiment described and illustrated herein are only examples and should not be considered as limitative of the scope of the present invention. Other variations and modifications may be made in accordance with the spirit and scope of the present invention.

For example, while, in the embodiment described above, in order to make it possible to drag the anchor icons, a description in JavaScript was installed in the information for displaying the pinup board screens and the editing screen for the pinup boards, it would also be acceptable to implement this by some other method. For example, it would also be possible to provide this function with FLASH (registered trademark) that is capable of displaying video, or with an applet in the JAVA (registered trademark) language, or the like. Moreover, some other method would also be acceptable.

Furthermore, it would also be acceptable to arrange to implement the screen where the pinup board screen and the editing screen of the pinup board are integrated. In this case, it would also be possible to provide an implementation in which the selection screen of the anchor icon to be deleted of FIG. 19 is not employed.

Moreover, it would also be possible, when an anchor icon is to be added to a pinup board, to make it possible to perform so called importation thereof from another pinup board.

Yet further, it would also be possible to make it possible to shift and to copy anchor icons between pinup boards.

As has been explained above, the operation support system of the present invention can be applied to a system that provides user support during operation for accessing content of various types.

What is claimed is:

1. An operation support system, comprising a client terminal device that comprises a display part and an operation input part and that is endowed with a browsing function; and an operation support server that is connected to said client terminal device via the internet and that, during browsing operation by said client terminal device, supports input operation by the user of said client terminal device,
wherein said operation support server comprises:
a storage part in which is stored pinup board information, for each user of said client terminal device, in which correspondence is maintained between display positions upon a pinup board screen of anchor icons each of which is an anchor symbol corresponding to a destination for access by said user, identifiers of said anchor icons, and access destination specifications corresponding to said anchor icons;
an updating part that, when a result of editing said pinup board information is received from said client terminal device, updates said pinup board information on the basis of said result of editing; and
a pinup board screen information return part that, when a request for information for display of said pinup board screen has been received from said client terminal device, generates a display information of said pinup board screen on the basis of said pinup board information, and returns said display information that has been generated to said client terminal device, and
wherein said client terminal device comprises:
an editing part that performs editing according to an editing command for said pinup board information inputted to said operation input part, and that sends said result of editing to said operation support server;
a pinup board request part that, when a command for display of said pinup board screen has been inputted to said operation input part, sends a request for information for display of said pinup board screen to said operation support server; and
a web access part that when, in response to the request for information for display of said pinup board screen, a selection has been inputted to said operation input part of a single anchor icon on a pinup board screen that has been displayed on the basis of the display information of said pinup board screen returned from said operation support server, accesses the access destination that corresponds to said selected anchor icon.

2. An operation support system according to claim 1, wherein the editing part that edits said pinup board information edits for addition of a new anchor icon, edits for changing of the display position of at least a single already existing anchor icon, and edits for deletion of at least a single already existing anchor icon.

3. An operation support system according to claim 1, wherein said editing part also performs editing for creation of a new pinup board.

4. An operation support system according to claim 3, wherein said new pinup board includes at least a single anchor icon displayed upon said pinup board screen.

5. An operation support system according to claim 4, wherein said editing part returns to said operation support server, as said result of editing, information for creating a new pinup board including an anchor icon that has been shifted to a predetermined region upon the editing screen of the pinup board that corresponds to said pinup board screen.

6. An operation support system according to claim 5, wherein:
said new pinup board is created at a lower level than the pinup board that corresponds to said pinup board screen, and
an icon for said new pinup board is displayed upon said pinup board screen.

7. An operation support system according to claim 1, wherein one of an access destination within said operation support server and an access destination within a server other than said operation support server, and is connected thereto by the internet, may be selected for the access destination that corresponds to each of said anchor icons.
